(19) United States
(12) Patent Application Publication
(10) Pub. No.: US 2026/0061375 A1
(43) Pub. Date: Mar. 5, 2026

(54) PROCESS FOR PREPARING STANDARD SYNTHETIC WATER-IN-OIL EMULSIONS AND SAID EMULSIONS

(71) Applicants: PETRÓLEO BRASILEIRO S.A. - PETROBRAS, Rio de Janeiro (BR); UNIVERSIDADE FEDERAL DO RIO DE JANEIRO — UFRJ, Rio de Janeiro (BR)

(72) Inventors: MARCO ANTONIO GOMES TEIXEIRA, Niterói (BR); AGNIS FERREIRA POLICARPO, Rio de Janeiro (BR); CLAUDIA REGINA ELIAS MANSUR, Rio de Janeiro (BR); ROGERIO MESQUITA DE CARVALHO, Rio de Janeiro (BR); SUZANNY PAIVA DE CARVALHO, Rio de Janeiro (BR); BRUNO DUARTE DA SILVA, Rio de Janeiro (BR); ANA MEHL, Rio de Janeiro (BR)

(73) Assignees: PETRÓLEO BRASILEIRO S.A. - PETROBRAS, Rio de Janeiro (BR); UNIVERSIDADE FEDERAL DO RIO DE JANEIRO — UFRJ, Rio de Janeiro (BR)

(21) Appl. No.: 19/310,642

(22) Filed: Aug. 26, 2025

(30) Foreign Application Priority Data
Sep. 2, 2024 (BR) 1020240180798

(51) Int. Cl. B01F 23/41

(52) U.S. Cl. CPC B01F 23/4105; B01F 23/4141

(57) ABSTRACT

The present invention falls within the petrochemical field, specifically in the field of developing standards for physical-chemical analyses. The present invention describes a process for preparing standard synthetic water-in-oil emulsions, which considers the application of the emulsion, the desired HLB, the type of surfactant to be used, and the characteristics of the aqueous and oil phases. The process results in water-in-oil emulsions with high stability. The emulsions obtained by the process of the present invention comprise a combination of surfactants, and present stability of up to 30 hours.

### CROSS-REFERENCE FOR RELATED APPLICATIONS

This application claims priority to Brazilian Application No. BR 1020240180798, filed on Sep. 2, 2024, the disclosure of which is herein incorporated by reference in the entirety.

### FIELD OF THE INVENTION

The present invention falls within the petrochemical field, specifically in the field of developing standards for physical-chemical analyses. The present invention describes processes for preparing standard synthetic water-in-oil emulsions, with application in physical-chemical analyses of mixtures in the oil industry, such as lifting and flow technologies, primary processing and oil recovery.

### BACKGROUNDS OF THE INVENTION

Emulsions are present in everyday life in several fields of activity, for example, in the petroleum, food, cosmetics and pharmaceutical industries. Emulsions consist of two immiscible liquids, usually oil and water, one being dispersed as small droplets in the other. The emulsions are classified based on the polarity of the dispersed phase in the external phase, also known as the continuous phase.

The most common types of emulsions are oil-in-water (O/W), where a nonpolar liquid (oil) is dispersed in a polar liquid (water), and water-in-oil (W/O) emulsions, where a polar liquid is dispersed in a nonpolar liquid. In addition, multiple emulsions can also be found, in which the dispersed phase is already an emulsion, such as (W/O/W) systems or (O/W/O) systems (MCCLEMENTS, 2015).

Considering the different nature of the phases, the emulsions are unstable systems. Thus, the stability of the emulsions is often maintained through the use of emulsifiers or surfactants (surfactants) that prevent or delay the phase separation. The emulsifying agents can be any surfactant compounds that are capable of reducing the interfacial tension between two liquids and keeping the droplets dispersed, minimizing the coalescence and aggregation. These stabilizers are divided into the following classes: anionic, cationic, nonionic and amphoteric (EL-DIN, 2011, SCHRAMM, 2006).

Another very important property in the emulsification process is the hydrophilic-lipophilic balance (HLB) of the surfactant. HLB is an empirical measurement that describes the relation between the hydrophilic and lipophilic parts of a surfactant molecule. This parameter is a useful indicator of the surfactant solubility and predicts the type of emulsion to be formed. Thus, the evaluation of HLB serves to empirically classify the type of emulsion that can be formed according to the amounts of lipophilic and hydrophilic systems present in a surfactant chain. Griffin (1949) established an empirical scale as a measure of the HLB values of the surfactants, which ranges from 0 to 20.

In some cases, the HLB number is calculated from the structure of the molecule; in other cases, it is based on experimental emulsification data (MCCLEMENTS, 2015, ROSEN, 2004, SJOBLOM, 2001). There is a relation between the HLB value of a surfactant and its application. The surfactant with a lower HLB has a lipophilic character and, therefore, works better to stabilize oil-in-water emulsions. On the other hand, a surfactant with a higher HLB value has a hydrophilic character and, therefore, is more suitable for water-in-oil emulsions (DELGADO-LINARES, MAJID, et al., 2013, KLOET, 2002). Mixtures of different surfactants can have their HLB calculated by the algebraic sum of the HLB of each surfactant individually, as seen in Equation 1:

$$HLB = \frac{{M}_{a} \times {HLB}_{a} + {M}_{b} \times {HLB}_{b}}{{M}_{a} + {M}_{b}} \qquad [ Equation 1 ]$$

wherein: Mₐ and M_{b} represent the mass of each surfactant and HLBₐ and HLB_{b} are the HLB values of each surfactant.

This concept is a great tool when it comes to studying formulations, since, from mixtures of pure surfactants, a wide range of HLBs can be obtained and, consequently, formulations with different characteristics for diverse applications. (PASQUALI, TAUROZZI, et al., 2008). In addition, for each purpose and application a certain stability of the used emulsion is required.

The stability of an emulsion is generally related to the resistance to the coalescence of dispersed droplets. The attractive Van der Walls forces and the repulsive interactions (electrostatic and steric) between the drops present in the system play an important role in the stabilization of the emulsion (DALTIN, 2011, TADROS, 2009). The stability of an emulsion can be affected by the following factors: drop size distribution, type and concentration of the emulsifier, quality of the interfacial film, viscosity of the continuous phase, temperature and pH, relation between volume fraction and phase density and salinity (ROSEN, 2004).

The viscosity of the continuous phase plays an important role in the mobility of the droplets in the medium; if this phase is too viscous, the Brownian motion (random movement of the particles suspended in a fluid) of the drops may be hindered and, consequently, the frequency of collision between the drops will decrease (MOBIUS, MILLER, et al., 2001). On the other hand, the distance between the dispersed droplets present in the continuous phase can be reduced, depending on the volume fraction of the aqueous and oil phases, due to the increase in the population density of the droplets (MIRHOSSEINI, TAN, et al., 2007).

The effects of the salinity on the emulsion stability vary according to the phase in which the salt is present, that is, when the salts are added to the continuous phase, the electrical layer that surrounds the surface of the drop shrinks and reduces the electrostatic barrier that prevents the coalescence process. However, this phenomenon does not occur when the salts are dissolved in the dispersed phase (TAMBE, SHARMA, 1993). Depending on the types of electrolytes, the repulsive electrostatic interactions of the interface can be neutralized by increasing the ionic strength (MCCLEMENTS, 2015). In addition, the salinity also has an impact on the non-ionic surfactants, and can alter their solubility, surface activity and adsorption (BELHAJ, ELRAIES, et al., 2020).

Furthermore, the drop size distribution (DSD) of an emulsion has a strong impact on its stability, viscosity and rheological behavior (SZYMANSKA et al., 2020) since it is directly related to the occurrence of destabilization processes governed by collision and/or diffusion mechanisms, such as: creaming, flocculation, (partial) Ostwald ripening coalescence and phase inversion (KOWALSKA et al., 2016, MIRHOSSEINI, TAN, et al., 2008). As a general rule, the smaller the droplets, the more stable the emulsions (MORADI et al., 2011, SJOBLOM et al., 2013). As the dispersed droplets aggregate by attractive forces, the agglomerates merge, increasing the droplet size (MAAREF et al., 2017). Stokes' law (Equation 2) states that the sedimentation rate is proportional to the drop size; thus, the larger the drop diameter, the faster the sedimentation and, consequently, the phase separation (DALTIN, 2011, EOW et al., 2001, MCCLEMENTS, 2011).

$$V = \frac{2 {R}^{2} \cdot g \cdot Δρ}{9 η} \qquad [ Equation 2 ]$$

wherein: V is the sedimentation velocity, r is the droplet radius, g is the acceleration of gravity, Δρ is the density difference between the two phases and η is the viscosity of the continuous phase (MCCLEMENTS, 2015).

Thus, different drop size distributions can be achieved, depending on the shear intensity to which the emulsion was subjected; so, it is extremely important to control the emulsification route to ensure the necessary stability. In addition, finding a reliable method for measuring drop size distribution is essential, since the emulsion stability is generally determined through methods based on droplet size distribution and/or methods based on phase separation over time (EL-DIN, 2011, MAAREF et al., 2017).

Due to their unique properties and versatility, the emulsions are widely used in various sectors, such as food, pharmaceuticals, construction, paints, textiles, agrochemicals, oil, among others. For example, in the oil industry, for product formulation or transfer operations (fluid flow), it is important to properly understand the behavior of the emulsions, especially for the preparation of stable emulsions that can be used in physical-chemical analyses. In applications involving water-in-oil emulsions, it is important to have standards or references that allow the verification of the results found and the reproduction of analyses performed.

In general, considering conventional approaches involving the oil field, emulsions are prepared by dispersing a certain amount of the aqueous phase (with known composition) in the continuous oil phase, in which the homogenization of the phases occurs through the use of mechanical stirring tools, such as high-speed stirrers or equipment known as turrax. Depending on the composition of the oil, the separation of the phases can occur in a matter of minutes. Thus, the instability of emulsions represents a difficulty in preparing standard solutions.

To avoid the phase separation, it is important that the preparation of the standard emulsions be carried out considering their application and the desired characteristics for the resulting standard emulsion. Thus, one way to enable greater stability of the standard emulsions is to consider the HLB of interest and evaluate the drop size distribution of the standard emulsions.

The studies by Liu, Z. et al. (2019), titled “Effect of surfactant HLB value on Methane hydrate formation in non-ionic surfactant-oil water emulsions systems”, published in Energy Procedia, evaluate the behavior of methane hydrate in different emulsions. To carry out this study, water-in-oil emulsions were prepared, using mineral oil as the oil phase, deionized water as the aqueous phase and the non-ionic surfactants Span 80 and Tween 80 in different proportions. Among the emulsions prepared, it was observed that many did not remain stable, with a fraction of oil separating at the top or some water at the bottom of the emulsion.

Monique Lombardo de Almeida's PhD Thesis (2019), titled “Estabilidade de Emulsões de Água-em-Óleo sob Ações Eletrocisalhantes e Campos Elétrico e Centrífugo” (“Stability of Water-in-Oil Emulsions under Electro-shearing Actions and Electric and Centrifugal Fields”) evaluates the stability of W/O emulsions under various conditions. This document discloses the production of W/O model emulsions, in which the model emulsions produced have mineral oil as the continuous phase and deionized water as the dispersed phase, and even disclose the use of conventional surfactants such as Span80 and Tween80. The surfactant mixtures were prepared so that the final HLB of all mixtures was equal to 5, in order to favor the formation of water-in-oil emulsions. However, the obtained emulsions did not show solubility in oil, only in water, which indicates that the external phase of the emulsion would be water and not oil, that is, O/W emulsions were prepared, in fact.

In addition, the studies by Colluci G. et al. (2020), titled “Development of Water-in-Oil Emulsions as Delivery Vehicles and Testing with a Natural Antimicrobial Extract”, published in Molecules, are aimed at developing a stable W/O emulsion system using natural almond oil as a base vehicle to incorporate natural hydrophilic extracts, employing different emulsifier mixture compositions, including Span80 and Tween80. Although they presented a stable W/O emulsion, almond oil was used, which does not resemble oils used in the petroleum field.

In this way, it is seen that there is a significant difficulty in preparing representative water-in-oil emulsions, which present similar properties and are stable for use as standard solutions. Thus, the present invention proposes the development of a process for preparing standard synthetic water-in-oil emulsions, which present good stability.

### BRIEF DESCRIPTION OF THE INVENTION

Initially, it should be noted that the following description is based on the preferred embodiments of the invention, without being limited by the same.

The present invention describes the development of standard synthetic water-in-oil emulsions for use in analyses in the oil industry. Thus, in one embodiment of the present invention, a process for preparing water-in-oil emulsions is presented, comprising steps that include defining one or more water:oil ratios in the emulsion, based on the interest of the application of the standard emulsion; and defining the composition/salinity of the aqueous phase and the type of oil to be used. In one embodiment of the present invention, from this information, the HLB of interest for the standard emulsion and one or more surfactants to be used are chosen. In one embodiment of the present invention, the process for preparing water-in-oil emulsions comprises steps of dissolving one or more surfactants specific to each phase of interest, in which the dissolution occurs according to the affinity between the phases, considering the proportions found from the HLB calculation; subsequent mixing of the phases; and homogenization of the mixture.

In a preferred embodiment of the invention, the water:oil ratio in the emulsion to be prepared is in the range of about 10:90 to about 40:60, and the aqueous phase has a salinity in a range of about 0 to about 400,000 mg of salt/L. In an additional embodiment of the invention, the aqueous phase has a salinity in a range of about 0 to about 220,000 mg of salt/L. In an additional embodiment of the invention, the oil phase comprises oil selected from the group consisting of crude oil, mineral oil, base oil, lubricating oil, drilling oil, synthetic oils, oily materials based on alpha-olefins or other oligomeric types, petroleum derivatives such as aviation kerosene, fuel oil or diesel, crude oil, and combinations thereof. In an additional embodiment of the invention, the HLB of interest of the emulsion is in the range of from about 4.3 to about 15.0. In a more preferred embodiment of the invention, the HLB is in the range of from 6 to 10. In an additional embodiment of the invention, about 1% to 5% (w/v) of one or more surfactants are added, based on the total amount of the emulsion. In a preferred embodiment of the invention, about 5% (w/v) of one or more surfactants are added, based on the total amount of the emulsion. In an additional embodiment of the invention, one or more surfactants are selected from the group consisting of sorbitan monooleate, ethoxylated/propoxylated sorbitan monooleate, sorbitan trioleate, ethoxylated/propoxylated sorbitan trioleate, sorbitan sesquioleate, ethoxylated/propoxylated sorbitan sesquioleate, sodium oleate, sodium stearate, calcium stearate, ethoxylated lauryl ether, ethoxylated castor oil, ethoxylated/propoxylated isotridecyl alcohol or combinations thereof. In an additional embodiment of the invention, the one or more hydrophilic surfactants are dissolved in the aqueous phase. In an additional embodiment of the invention, the one or more hydrophobic surfactants are dissolved in the oil phase. In an additional embodiment of the invention, the process for preparing water-in-oil emulsions comprises mixing the phases by pouring the aqueous phase into the oil phase. In a preferred embodiment of the invention, the pouring of the aqueous phase into the oil phase occurs slowly. In one embodiment of the present invention, the process for preparing water-in-oil emulsions comprises a homogenization step through vigorous stirring. In a preferred embodiment of the invention, the vigorous stirring occurs with mechanical stirring systems with a rotation speed between about 3,000 and about 13,000 rpm. In an additional embodiment of the present invention, the process for preparing water-in-oil emulsions additionally comprises a step of characterizing the emulsion. In an additional embodiment of the present invention, the process for preparing water-in-oil emulsions comprises the characterization of the emulsion through drop size analysis, solubility testing in aqueous and oily medium, wettability tests, membrane filtration, interface tests, and spectrophotometry.

In one embodiment of the present invention, there are provided water-in-oil emulsions comprising about 10% to about 40% of an aqueous phase, based on the total weight of the emulsion, dispersed in about 60% to about 90% of an oil phase, based on the total weight of the emulsion; and from about 1% (w/v) to about 5% (w/v) of one or more surfactants; wherein the water-in-oil emulsion exhibits high stability. In a preferred embodiment of the present invention, the water-in-oil emulsion comprises about 5% (w/v) of surfactants, based on the emulsion. In an additional embodiment of the present invention, the water-in-oil emulsion comprises an aqueous phase with a salinity in a range of about 0 to about 400,000 mg/L. In a preferred embodiment of the present invention, the water-in-oil emulsion comprises an aqueous phase with a salinity in a range of from about 0 to about 220,000 mg/L. In an additional embodiment of the present invention, the oil phase comprises oil selected from the group consisting of crude oil, mineral oil, base oil, lubricating oil, drilling oil, synthetic oils, oily materials based on alpha-olefins or other oligomeric types, petroleum derivatives such as aviation kerosene, fuel oil or diesel, crude oil, and combinations thereof. In an additional embodiment of the present invention, the water-in-oil emulsion comprises one or more hydrophilic surfactants. In an additional embodiment of the present invention, the water-in-oil emulsion comprises one or more hydrophobic surfactants. In an additional embodiment of the present invention, the water-in-oil emulsion comprises a surfactant selected from the group consisting of sorbitan monooleate, ethoxylated/propoxylated sorbitan monooleate, sorbitan trioleate, ethoxylated/propoxylated sorbitan trioleate, sorbitan sesquioleate, ethoxylated/propoxylated sorbitan sesquioleate, sodium oleate, sodium stearate, calcium stearate, ethoxylated lauryl ether, ethoxylated castor oil, ethoxylated/propoxylated isotridecyl alcohol, or combinations thereof. In an additional embodiment of the present invention, the water-in-oil emulsion has an HLB value between about 4.3 and about 15, preferably between about 6 and about 10, more preferably an HLB of about or equal to 6. In an additional embodiment of the present invention, the water-in-oil emulsion is prepared by the water-in-oil emulsion preparation process of the present invention. In an additional embodiment of the present invention, the water-in-oil emulsion has high stability. In an additional embodiment of the present invention, the water-in-oil emulsion is stable for at least 5 h. In a preferred embodiment of the present invention, the water-in-oil emulsion is stable for at least 30 h. In an additional embodiment of the present invention, the water-in-oil emulsion has a dispersion of drops with drop sizes in the range of 1 to 10 μm. In an additional embodiment of the present invention, the water-in-oil emulsion has a white or off-white appearance. In an additional embodiment of the present invention, the water-in-oil emulsion has an opaque appearance. In an additional embodiment of the present invention, the water-in-oil emulsion is free of characteristic odor. In an additional embodiment of the present invention, the water-in-oil emulsion is a standard synthetic water-in-oil emulsion. In an additional embodiment of the present invention, the water-in-oil emulsion is for application in physicochemical analyses in the petroleum field.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the nature and objectives of the present invention, in order to assist in the identification of the main characteristics of the composition of the present invention and its technical results and effects, the figures to which references are made are presented, as follows:

FIG. 1 presents the solubility tests of the emulsions with 33% distilled water, 67% mineral oil and 5% m/v of various non-ionic surfactants.

FIG. 2 presents micrographs referring to the 33W:67O emulsion with 5% m/v Span 80, processed with Polytron at different stirring speeds and with a mechanical stirrer, with 20× magnification.

FIG. 3 presents the micrographs of the 33W:67O emulsion with 5% m/v of the Tween 80:Span 80 mixture with the following HLB values: 6, 8, 9 and 10, and with 20× magnification.

FIG. 4 presents the micrographs of the 33W:67O emulsion with 5% m/v of the Tween 80:Span 80 mixture—HLB 6, processed with Polytron, mechanical stirrer, magnetic stirrer and glass rod, with 20× magnification.

FIG. 5 presents the drop sizes (d_{0.1}, d_{0.5}, d_{0.9}) as a function of the sampling time of the water-in-oil emulsion.

FIG. 6 presents a micrograph of the 30:70 water-in-oil (W_{A}:O_{A}) emulsion with a 5% w/v surfactant mixture (T_{w80}Sₚ₈₀) freshly prepared and after 30 hours of rest.

FIG. 7 presents the drop size parameters (d₄₃, d₃₂) and confidence interval as a function of the sampling time of the water-in-oil emulsion.

FIG. 8 presents the range of drop size parameters (d_{0.1}, d_{0.5}, d_{0.9}, d₄₃, d₃₂) as a function of the sampling time of the water-in-oil emulsion prepared with different mineral oils, that is, O_{A}, O_{B}.

FIG. 9 presents the drop size distribution, d₃₂ (average diameter of the volume surface), for an emulsion prepared with different concentrations of NaCl (35,000, 55,000, 140,000 or 220,000 mg/L) as a function of the sampling time.

FIG. 10 presents the Turbiscan profile in the transmission signal over the height of the vial and time (5 h) for the water-in-oil emulsion sample.

FIG. 11 presents the Turbiscan profile in the backscatter signal over the height of the vial and time (5 h) for the water-in-oil emulsion sample.

FIG. 12 presents the TSI value of the 30% W_{A}:70% O_{A} 5% m/v T_{w80}:Sₚ₈₀ emulsion as a function of time (T=30° C.).

### DETAILED DESCRIPTION OF THE INVENTION

The present invention discloses processes for the preparation of standard synthetic water-in-oil emulsions. In the oil industry, several physical-chemical analyses are performed, for example, for product formulation, transfer operations, quality control, standardization, monitoring operations, among others. For example, for the calibration of measurement systems, it is of fundamental importance to have a reference emulsion that allows an unequivocal evaluation of the processes under development, regardless of the level of maturity. In other words, finding a reference system can assist in the design of desired products, in the validation of new methodologies and in the investigation of complex dispersed systems in general.

To this end, it is important to have a proper understanding of the behavior of the emulsions, mainly for the preparation of stable emulsions that can be used in these physical-chemical analyses. Consequently, it is important to have standards or references that allow the verification of the found results. However, since emulsions are systems with two or more phases, their instability represents a problem in the preparation of standard solutions for application in physical-chemical analyses.

To avoid the phase separation, it is necessary to prepare the standard emulsions considering their application, which characteristics are desired for the resulting standard emulsion and which behavior should be obtained. In this way, the inventors found that a way to enable a greater stability of the standard emulsions is to consider the HLB of interest. In addition, the evaluation of the drop size distribution of the standard emulsions is also necessary. Thus, the present invention proposes the development of a process for preparing standard synthetic water-in-oil emulsions, which present good stability.

The emulsions can be prepared in different proportions of water and oil. If the objective is to prepare a model system, mineral oil with known composition and properties can be used. Petroleum can also be used instead of mineral oil, in situations in which the system needs to be closer to the real one.

Thus, in one embodiment of the present invention, a process for preparing water-in-oil emulsions is presented, comprising steps that include defining one or more water:oil ratios in the emulsion, based on the interest of the application of the emulsion. In an additional embodiment of the invention, the water:oil ratio in the emulsion to be prepared is in the range of about 10:90 to about 40:60. In a preferred embodiment of the invention, the water:oil ratio in the emulsion to be prepared is in the range of about 30:70 to about 40:60.

The salinity of the aqueous phase can also influence the stability of the resulting emulsions. When preparing standard water-in-oil emulsions, it is important to keep in mind the composition of the aqueous phase employed. Thus, in one embodiment of the present invention, the process for preparing water-in-oil emulsions comprises the step of defining the composition/salinity of the aqueous phase. The aqueous phase may consist of brines with salinity in a range of about 0 to 400,000 mg salt/L, preferably brines with salinity in a range of about 0 to about 220,000 mg salt/L. Thus, in an additional embodiment of the invention, the aqueous phase has salinity in a range of about 0 to about 400,000 mg salt/L. In a preferred embodiment of the invention, the aqueous phase has salinity in a range of about 0 to about 220,000 mg salt/L.

In addition, the characteristics of the oil phase also impact the stability of emulsions. In this way, it is important to select the oil to be used. Thus, in one embodiment of the present invention, the process for preparing water-in-oil emulsions comprises the step of defining the type of oil of interest for the oil phase. The viscosity of the oil used in the emulsion preparation process also influences the stability of the resulting emulsion.

Thus, in an additional embodiment of the invention, the oil is selected from the group consisting of crude oil, mineral oil, base oil, lubricating oil, drilling oil, synthetic oils, oily materials based on alpha-olefins or other oligomeric types, petroleum derivatives such as aviation kerosene, fuel oil, diesel, crude oil, and combinations thereof, without restricting the scope of protection of the present invention.

Once the water:oil ratio to be used, the composition of the aqueous phase and the oil phase have been defined, and, bearing in mind the application of the resulting emulsion, it is possible to determine the HLB of interest for the emulsion (considering its application) and the surfactants to be used. Calculating the HLB is important to predict the type of emulsion that will be formed. Thus, in one embodiment of the present invention, based on the information on the water:oil ratio and the type of oil to be used, the HLB of interest for the emulsion is chosen. In an additional embodiment of the invention, the HLB of interest for the emulsion is in the range of about 4.3 to about 15.0, preferably in the range of about 6 to about 10. In an even more preferred embodiment, the HLB is equal to or about 6.

Additionally, in one embodiment of the present invention, based on the information on the water:oil ratio and the type of oil to be used, the one or more surfactants to be used are chosen. The combination of different surfactants results in greater efficiency in the preparation of emulsions. In this way, to prepare a stable emulsion, surfactants are combined in order to achieve a desired HLB value. The mixtures can be prepared in different proportions, in order to obtain different HLB values. In this way, the stability can be modulated over time, depending on the proposed use.

The type of surfactant to be used is important, depending on the application of the standard emulsion. In addition, it is important to keep in mind the affinity of the surfactant for the phase in which it will be dispersed. Thus, in one embodiment of the present invention, the process for preparing water-in-oil emulsions comprises the step of dissolving one or more specific surfactants for each phase of interest, in which the dissolution occurs according to the affinity between the phases, considering the proportions found from the HLB calculation.

Thus, in an additional embodiment of the invention, from about 1% (w/v) to about 5% (w/v) of one or more surfactants are added, based on the total amount of the emulsion, preferably about 5% (w/v) of one or more surfactants are added, based on the total amount of the emulsion. In a further embodiment of the invention, the one or more surfactants are selected from the group consisting of sorbitan monooleate, ethoxylated/propoxylated sorbitan monooleate, sorbitan trioleate, ethoxylated/propoxylated sorbitan trioleate, sorbitan sesquioleate, ethoxylated/propoxylated sorbitan sesquioleate, sodium oleate, sodium stearate, calcium stearate, ethoxylated lauryl ether, ethoxylated castor oil, ethoxylated/propoxylated isotridecyl alcohol, or combinations thereof, without restricting the scope of protection of the invention. In an additional embodiment of the invention, the one or more hydrophilic surfactants are dissolved in the aqueous phase; and the one or more hydrophobic surfactants are dissolved in the oil phase.

The step of mixing the different phases is also important for the stability of the emulsion, since different droplet size distributions can be achieved, depending on the intensity of shear to which the emulsion was subjected. Thus, in one embodiment of the present invention, the process for preparing water-in-oil emulsions comprises steps of mixing the phases; and subsequent homogenization of the mixture. In an additional embodiment of the invention, there is the mixing of the phases through the pouring of the aqueous phase into the oil phase. In a preferred embodiment of the invention, the pouring of the aqueous phase into the oil phase occurs slowly. In one embodiment of the present invention, the homogenization step occurs through vigorous stirring with mechanical stirring systems with a rotation speed in the range of about 3000 to about 13000 rpm.

In order to verify the success of the preparation of water-in-oil emulsions, that is, whether the process achieved its objective of preparing a water-in-oil emulsion and not an oil-in-water emulsion, it is necessary to characterize the emulsions. Tests are performed to verify, for example, the drop size distribution and the emulsion solubility. These characterization tests must be performed after the preparation of the emulsions, and with a certain frequency, in order to ensure that the emulsion remains stable. Thus, in one embodiment of the present invention, the process for preparing water-in-oil emulsions additionally comprises the emulsion characterization step. The characterization of the emulsions comprises several tests that are used to ensure that the prepared emulsions are of the water-in-oil type, that is, to verify the success of the preparation process. In this way, in an additional embodiment of the present invention, the process for preparing water-in-oil emulsions comprises the characterization of the emulsion occurring through drop size analysis, solubility testing in aqueous medium and in oily medium, wettability tests, membrane filtration, interface tests, dye diffusion, and spectrophotometry.

For example, it is possible to perform solubility tests by mixing emulsions prepared in the constituent phases of the emulsion, that is, in distilled water, brine or oil. The continuous phase (external phase) of the emulsion and the emulsion exhibit similar wettability and dispersion properties. In this way, if a small amount of an oil-in-water (O/W) emulsion was poured into an aqueous medium, its continuous phase would dissolve in the aqueous solvent and its oil droplets would be dispersed. In turn, a water-in-oil (W/O) emulsion would solubilize in the presence of an organic and/or oily medium. Accordingly, in order to prove that a water-in-oil emulsion is in fact of the W/O type, it is important that the emulsion is soluble in an oily medium.

These tests also allow the stability of the emulsion to be assessed. Thus, it is seen that the process of preparing water-in-oil emulsions results in emulsions with high stability.

The stable emulsions prepared by the process of the present invention function as reference emulsions with application for carrying out physicochemical analyses to be used for the construction of a calibration model; comparison between different techniques in different laboratories (verifying repeatability and reproducibility); and even definition of a basis for comparison. Thus, the emulsions of the present invention have application as standard synthetic water-in-oil emulsions for physicochemical analyses.

The emulsions obtained by the process of preparing water-in-oil emulsions of the present invention comprise from about 10% to about 40% of an aqueous phase, based on the total weight of the emulsion, as a dispersed phase. In addition, the emulsions obtained by the present invention comprise from about 60% to about 90% of an oil phase, based on the total weight of the emulsion, as a continuous phase. Additionally, the emulsions of the present invention comprise from about 1% to about 5% of one or more surfactants.

Thus, in one embodiment of the present invention, there are presented water-in-oil emulsions comprising from about 10% to about 40% of an aqueous phase, based on the total weight of the emulsion, dispersed in from about 60% to about 90% of an oil phase, based on the total weight of the emulsion; and from about 1% (w/v) to about 5% (w/v), preferably about 5% (w/v) of one or more surfactants; wherein the water-in-oil emulsion exhibits high stability.

The salinity in the aqueous phase of the emulsion has an influence on the stability of the resulting emulsions. The aqueous phase may consist of brines with a salinity in a range of about 0 to 400,000 mg salt/L, preferably brines with a salinity in a range of about 0 to about 220,000 mg salt/L. Thus, in an additional embodiment of the present invention, the water-in-oil emulsion comprises an aqueous phase with a salinity in a range of about 0 to about 400,000 mg salt/L, preferably in a range of about 0 to about 220,000 mg salt/L.

In addition, the viscosity of the oil employed in the emulsion influences the stability of the emulsion. Thus, in an additional embodiment of the present invention, the oil phase comprises oil selected from the group consisting of crude oil, mineral oil, base oil, lubricating oil, drilling oil, synthetic oils, oily materials based on alpha-olefins or other oligomeric types, petroleum derivatives such as aviation kerosene, fuel oil or diesel, crude oil, and combinations thereof, without restricting the scope of protection of the invention.

The water-in-oil emulsion of the present invention comprises a combination of surfactants. Thus, in an additional embodiment of the present invention, the water-in-oil emulsion comprises one or more hydrophilic surfactants and one or more hydrophobic surfactants.

The surfactants of the water-in-oil emulsion are selected from the group consisting of sorbitan monooleate, ethoxylated/propoxylated sorbitan monooleate, sorbitan trioleate, ethoxylated/propoxylated sorbitan trioleate, sorbitan sesquioleate, ethoxylated/propoxylated sorbitan sesquioleate, sodium oleate, sodium stearate, calcium stearate, ethoxylated lauryl ether, ethoxylated castor oil, ethoxylated/propoxylated isotridecyl alcohol, or combinations thereof, without restricting the scope of protection of the present invention.

The combination of the surfactants allows obtaining emulsions with desirable characteristics according to the application of interest. Thus, in an additional embodiment of the present invention, the water-in-oil emulsion has an HLB value between about 4.3 and about 15, preferably between about 6 and about 10, more preferably an HLB of about 10, even more preferably an HLB equal to or about 6.

The emulsions obtained by the preparation process of the present invention have a white or off-white appearance, are opaque, have no characteristic odor and are highly stable.

As previously mentioned, the stability can be influenced by many factors, such as salinity. For a salinity of 35,000 mg/L, the emulsions of the present invention have stability of up to 30 hours. For higher salinity values, the emulsions are stable for up to 5 hours. Thus, in an additional embodiment of the present invention, the water-in-oil emulsion is stable for at least approximately 5 h. In a preferred embodiment of the present invention, the water-in-oil emulsion is stable for at least approximately 30 hours.

The high stability of the emulsions is also related to the dispersion of drop sizes present in the emulsion. As a general rule, the smaller the droplets, the more stable the emulsions. The drop size measurement is performed to evaluate the effectiveness of the mixture, its characterization and control. The size range should be between about 1 and about 10 μm, in order to obtain the stability time previously described. Thus, in an embodiment of the present invention, the water-in-oil emulsion presents drop dispersion with a drop size in the range of about 1 and about 10 μm.

The emulsions prepared by the process of the present invention are stable, and have the advantage of offering reliability in the applied analyses, as it allows the calibration of measurement systems, enabling greater reliability in the control of processes and product quality, such as, for example, water content in exported oil.

Another application example, for calibration of measurement systems, whether stability assessment systems, determination of the water content, development of formulations, among others, is of fundamental importance to have a reference emulsion that allows an unequivocal evaluation of the processes under development, regardless of the level of maturity. In this way, the present invention allows the preparation of samples with known concentrations of water, in order to provide the construction of a calibration model for measurement systems.

In addition, the present invention also has the advantage of enabling the development of new methodologies and formulations involving water-in-oil emulsions.

The invention may also be further described by means of the following non-limiting examples. Those skilled in the art will appreciate the knowledge presented herein and will be able to reproduce the invention in the embodiments presented and in other variants, encompassed by the scope of the appended claims.

### Preparation and Evaluation of Water-In-Oil Emulsions According to the Invention

In order to determine the characteristics of the water-in-oil emulsions, tests were carried out varying the surfactant to be used. Thus, in an example of embodiment of the invention, a 33W:67O emulsion was prepared with 5% m/v of Tween 80 (ethoxylated sorbitan monooleate), with homogenization with a Polytron rotor-stator type homogenizer with a rotation speed of 13,000 rpm for 5 minutes. In addition, the type of nonionic surfactant was varied, selected from Ultrol L70 (ethoxylated lauryl alcohol, with HLB 12.3), Ultramona R150 (ethoxylated castor oil, with HLB 8.3), Alkomol IT 406 (ethoxylated and propoxylated isotridecyl alcohol, with HLB 6.5), and Span 80 (sorbitan monooleate, with HLB 4.3).

To characterize these emulsions, only the solubility test was used in this step. To perform the solubility test, 1 mL of emulsion was transferred to the bottom corner of a 50 mL beaker and then 20 mL of solvent was added. After the solvent transfer, the beaker was manually and gently stirred for 30 seconds and left to rest for 15 minutes. Another manual stirring of 30 seconds was performed after the resting time. The emulsions were subjected to the solubility test in distilled water and mineral oil in order to identify the affinity and the continuous phase of the emulsion. The main desired characteristic was that the emulsion obtained would be soluble in oil and insoluble in distilled water.

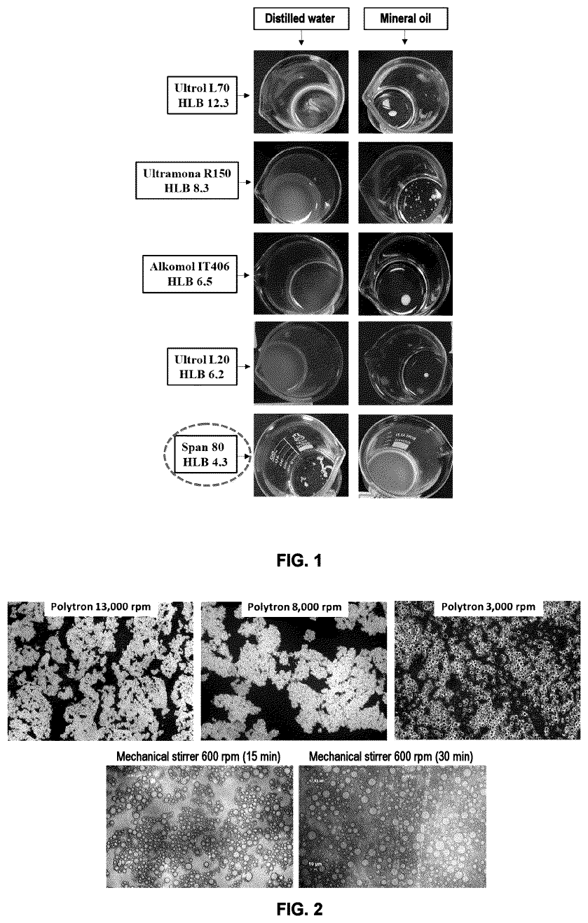

FIG. 1 presents the photographic records of the solubility tests in distilled water and mineral oil of the emulsions prepared with 33% aqueous phase (distilled water), 67% oil phase (mineral oil, from Isofar) and 5% m/v of varied nonionic surfactants with different HLB values.

It can be observed that using this proportion of aqueous and oil phase, the HLB range of 12.3 to 6.2 did not produce oil-soluble emulsions. Only the system using Span80 (sorbitan monooleate) with HLB 4.3 presented solubility in mineral oil, indicating that it was a W/O emulsion.

These results are in accordance with the scale proposed by Griffin, which suggests that surfactants with HLB values between 4 and 6 produce W/O emulsions.

In addition, to determine the characteristics of the water-in-oil emulsions, tests were performed varying the preparation method. Thus, in an example of an embodiment of the invention, a 33W:67O emulsion was prepared with 5% m/v of Span80 (which was shown to be soluble in mineral oil, therefore, a W/O emulsion), in which new tests were performed to investigate the stability of the emulsion, by means of visual monitoring and the appearance of the drops formed, with the aid of optical microscopy.

The initial emulsion was prepared using a Polytron rotor-stator type homogenizer at a rotation speed of 13,000 rpm for 5 min. It was stable, but did not form droplets, but rather agglomerated lumps that were impossible to measure. Given this, other rotation speeds in the Polytron (3,000 rpm to 13,000 rpm) and the use of a mechanical stirrer (600 rpm) were evaluated in the preparation of the emulsion.

As presented in FIG. 2, the drops were formed as the stirring speed was reduced, both in the Polytron and in the mechanical stirrer. Larger drops were formed when the mechanical stirrer was used. The size of the drops is related to factors such as: geometry of the head of the part used in the mixing, the container in which the mixing is done and the number of passes of the components through the mixing zone. For this reason, the decrease in shear promotes the formation of larger drops. However, the emulsions obtained were quite unstable, since the stability is intrinsically linked to the size and distribution of drop sizes. It is known that the larger the drop size, the greater the force of attraction between the same, thus favoring the coalescence, and according to Stokes' Law, the drop size directly influences the sedimentation rate and phase separation. Accordingly, to prepare stable emulsions, emulsions with smaller drop sizes were sought.

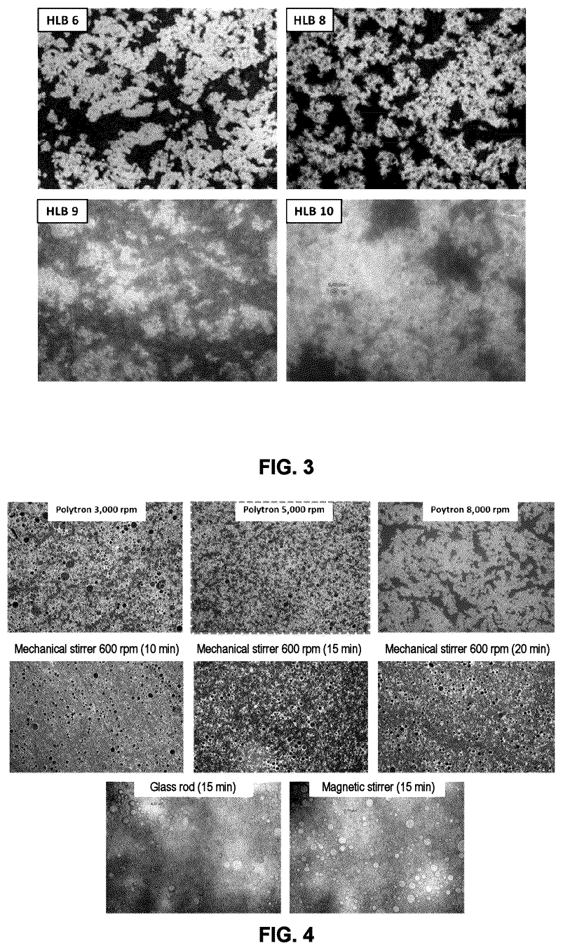

Considering that the combination of surfactants with different HLB values allows obtaining several emulsions with characteristics that can be modulable, tests were carried out for different combinations of surfactants. Thus, in an example of embodiment of the invention, 33W:67O emulsions were prepared with 5% m/v of a mixture of Tween80 and Span80 with the following HLB values: 6, 8, 9 and 10. The non-ionic surfactants Span 80 and Tween 80 were chosen to prepare the emulsions, since each surfactant has an affinity for a phase. Firstly, the emulsions were processed in the Polytron rotor-stator type homogenizer at a rotation speed of 13,000 rpm for 5 minutes. FIG. 3 presents the micrographs of the emulsions for each HLB value used, and it is possible to observe that the incorporation of Tween 80 only became efficient for the formation of drops in the mixture with an HLB value of 10. For the mixtures with lower HLB values, a greater quantity of Span 80 than Tween 80 is used, and for this reason the appearance of the emulsions formed is similar to those obtained for the emulsions using only Span 80, where lumps are formed. The fact that Span 80 is solubilized in the oil, in amounts greater than those of Tween 80, and the content of the oil phase is much greater than the aqueous phase, may be facilitating the protagonism of Span 80, mainly in the systems with HLB values of 6 and 8.

Although all systems using a mixture of Tween 80 and Span 80 showed high stabilities, the one with an HLB value of 6 demonstrated superior results due to the presence of the droplets, which are important, measurable properties and allow the characterization of the stability and reproducibility of the prepared emulsions.

In addition, other tests were also performed to determine the best methodology for preparing the emulsions. For this purpose, in addition to the Polytron homogenizer and the mechanical stirrer, the magnetic stirrer and manual stirring with a glass rod were evaluated. FIG. 4 shows the micrographs of the 33W:67O emulsion with 5% m/v of a mixture of Tween 80 and Span 80 with an HLB value of 6. It can be observed that with the very low rotation speed in the Polytron, with the magnetic stirrer and with manual stirring using a glass rod, the drops formed are quite irregular and of varying sizes. In the processing using a mechanical stirrer, the process duration did not influence the size of the drops after 15 minutes. The stirring speed of 5,000 rpm proved to be efficient in terms of the formation of identifiable and measurable droplets. For this reason, these conditions were chosen to continue the future steps, since the Polytron homogenizer has the greatest capacity to generate reproducible emulsions, when compared to the other preparation methods evaluated.

Thus, it is seen that a W/O model emulsion with 33W:67O with 5% m/v of a mixture of Tween 80 and Span 80 with an HLB value of 6 proved to be promising. To verify the stability and reproducibility of the emulsions, the proportion of aqueous and oil phases was tested for 30W:70O, with the same concentration of surfactant.

Thus, in an example of a preferred embodiment of the invention, the surfactants ethoxylated sorbitan monooleate (Tween 80) and sorbitan monooleate (Span 80) were used. Three types of oil were tested as continuous phases: EMCAplus 070 mineral oil (O_{P}); general purpose mineral oil (O_{B}), and light mineral oil (O_{C}), and the aqueous phase was pure deionized water (W_{A}) or with different concentrations of sodium chloride (35,000, 55,000, 140,000 or 220,000 mg/L of NaCl, W_{B}). Their physicochemical properties are listed in Table 1.

TABLE 1
Chemical properties of the reagents

| | Properties | | | |
|---|---|---|---|---|
| | | Density (g/cm³ −20° | Viscosity | Molar mass |
| Reagents | HLB | C.) | (cP) | (g/mol) |
| Mineral | — | 0.832-0.865 | ~18 | — |
| oil (O_{A}) | | | | |
| Mineral | — | 0.820-0.880 | ~17 | — |
| oil (O_{B}) | | | | |
| Mineral | — | 0.833 | ~24 | — |
| oil (O_{C}) | | | | |
| Tween 80 | 15.0 | 1.060-1.090 | — | 1309.63 |
| Span 80 | 4.3 | 0.990-0.994 | — | 428.62 |

In order to achieve greater stability, an emulsion comprising a mixture of emulsifiers was designed. Thus, emulsions with combined emulsifying agents were prepared, considering possible resulting mixtures between the emulsifiers Tween 80 (Tw80) and Span 80 (Sp80). The HLB equation was applied to calculate the necessary quantity of each surfactant to achieve a value of HLB=6 in the emulsion to be prepared.

Thus, considering an application for emulsions with a water concentration of 30%, emulsions were prepared in a volumetric ratio of 30:70 (V_{water}/V_{mineral oil}), at room temperature (25±1° C.). The concentration of the surfactants in the emulsion was 5% (w/v) based on the total amount of the emulsion, in which the mass ratio between Tw80 and Sp80 was approximately 17:83. Each surfactant was dissolved separately in its affinity phase, that is, Tw80 in the aqueous phase and Sp80 in the oil phase. After complete dissolution of the surfactant, the aqueous phase was slowly added to the oil phase and pre-stirred with a glass rod in a cross motion, dragging it along the bottom of the beaker for 1 minute, to facilitate the incorporation of both phases. Next, the emulsion was homogenized in a rotor-stator system at 5,000 rpm for 5 minutes. Thus, the resulting emulsions comprised an aqueous phase, an oil phase and the mixed surfactants. The resulting emulsions presented characteristics of white, opaque color, oily appearance, non-volatile and without characteristic odor.

The prepared water-in-oil emulsions were placed in a 100 mL glass vial for emulsion stability analysis, and the results were presented as average±standard deviation (SD) values. A statistical analysis was performed on the results for the synthetic emulsions, and confidence intervals (95%) were obtained for the drop size distribution parameters. All the measurements per batch were made in triplicate readings, with standard deviation.

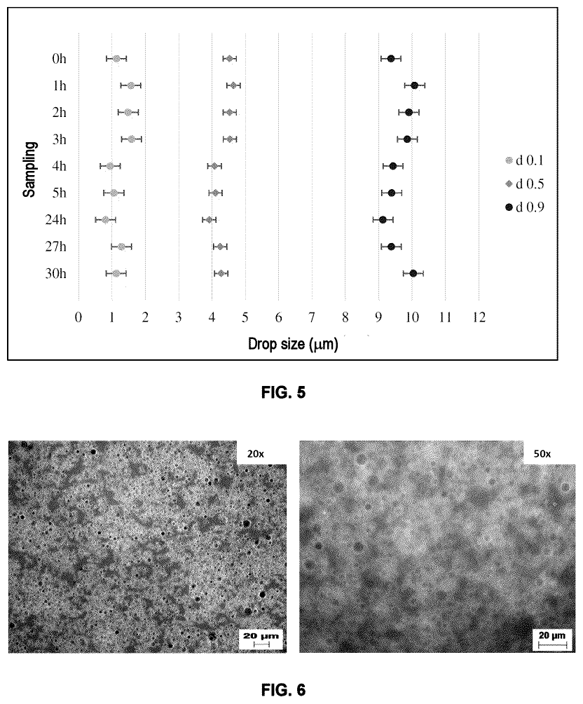

Droplet size distribution: Samples of water-in-oil emulsion with 30% W_{A} and 70% O_{A} content were prepared and investigated in order to determine the drop size parameters (d_{0.1}, d_{0.5}, d_{0.9}, d₄₃, d₃₂) and the dispersion value (α) over a period of up to 30 hours. The visual stability of the sample was also carefully monitored during this period, and the results of the drop size and of the confidence interval obtained are shown in FIG. 5 and Table 2.

The drop size distribution was determined using a Mastersizer Micro laser diffraction particle size analyzer (Malvern), in the size range 0.1-1000 μm. The samples were added dropwise to the dispersion unit (model Hydro) containing the same mineral oil with which the emulsion was prepared, under stirring (17,000 rpm), until the obscuration was within the acceptable range (10-20%) (BRYANT et al., 2020). The mineral oil used in the dispersion unit was degassed and sonicated for 1 hour to avoid the generation of bubbles in the system.

The intensity of the scattered light was correlated to the drop size based on the Mie Theory model (ISO, 2009; Stauffer, 1997). The measurements resulted in a data set comprising: percentage readings of equivalent diameters d_{0.1}, d_{0.5}, d_{0.9}—that is, droplet diameters in which 10, 50 or 90% of the population are equal to or smaller than the measured size (GOUAOU et al., 2019). The average drop size was characterized by the average diameters d₄₃ (weight-volume average diameter) and d₃₂ (volume-surface average diameter), defined according to Equations 3 and 4 (SAMAVATI et al., 2013):

$${d}_{43} = \frac{\sum {n}_{i} {d}_{i}^{4}}{\sum {n}_{i} {d}_{i}^{3}} \qquad [ Equation 3 ]$$

$${d}_{43} = \frac{\sum {n}_{i} {d}_{i}^{3}}{\sum {n}_{i} {d}_{i}^{2}} \qquad [ Equation 4 ]$$

where nᵢ is the number of drops with diameter dᵢ.

The distribution width of the drops in dispersion (α) was calculated according to Equation 5 (VLADISAVLJEVIĆ, SCHUBERT, 2003):

$$α = \frac{{d}_{0.9} - {d}_{0.1}}{{d}_{0.5}} \qquad [ Equation 5 ]$$

The measurements were performed immediately after the emulsion preparation (time 0 h) and over 30 hours, at least in triplicate readings at room temperature (25±1° C.)

FIG. 5 shows the drop size as a function of the sampling time of the water-in-oil emulsion. During the entire 30 h period evaluated, there were no major variations in the drop size distribution (DSD), only fluctuations with drop diameters in the range of 0.8-10.1 μm for all drop size parameters determined (d_{0.1}, d_{0.5}, d_{0.9}). In addition, the visual monitoring confirmed that the resulting emulsion was quite stable, with no evidence of droplet coalescence, that is, no free water layer formation was detected during 30 hours.

The stability of a water-in-oil emulsion is defined as the resistance of the dispersed water droplets to coalescence, and this factor is strongly related to the emulsion production method and its composition. In this case, the long-term stability of the emulsion can be attributed to the lipophilic character of the surfactant mixture, which led to the stabilization of the water-oil interfaces of the droplets. As reported by Delgado-Linares et al., the application of surfactant mixtures to stabilize emulsions has been shown to be, in most cases, more efficient than a single surfactant, due to synergistic mechanisms that reduce droplet coalescence (DELGADO-LINARES, MAJID, et al., 2013, TADROS, T, 2005).

In addition, the lower water content also played an important role in the emulsion stability, since the homogenization provides greater distances between the emulsified water drops, resulting in lower drop-drop collision frequencies, allowing longer times for development and maintenance of the interfacial film (SULLIVAN et al., 2007). Most of the dispersed droplet size values obtained are within the limits of the calculated confidence intervals, as shown in Table 2.

TABLE 2
Drop size parameters (d₄₃, d₃₂) and dispersion values (α)
as a function of the sampling time of the water-in-oil emulsion

| | Drop size (μm) | | |
|---|---|---|---|
| Sampling (h) | d₄₃ | d₃₂ | α |
| T0 | 5.1 | 2.6 | 1.8 |
| T1 | 5.5 | 2.8 | 1.8 |
| T2 | 5.3 | 2.7 | 1.9 |
| T3 | 5.6 | 2.8 | 1.8 |
| T4 | 4.8 | 2.3 | 2.1 |
| T5 | 4.9 | 2.4 | 2.0 |
| T24 | 4.6 | 2.2 | 2.1 |
| T27 | 5.0 | 2.6 | 1.9 |
| T30 | 5.7 | 2.5 | 2.1 |
| C.I. | 4.9-5.4 | 2.4-2.7 | — |
| S.D. | ±0.4 | ±0.2 | |

wherein: C.I. refers to the confidence interval. S.D. refers to the standard deviation.

The emulsion presented a relatively uniform distribution; although the sample was not monodispersed, the dispersion values (av) were approximately constant, varying between values of 1.8 and 2.1 over time.

In addition, FIG. 6 shows an example of a microscopy image of the appearance of the emulsion with 30% WA and 70% O_{A} content prepared with a 5% w/v surfactant mixture (Tw₈₀Sp₈₀). The microstructure of the emulsion was observed under an optical microscope (model Axio Vert-A1, Zeiss) with 20× and 50× magnification for qualitative evaluation. The images were captured with the AxioVision Rel. 4.8 software (Zeiss). The smaller the drop diameter, the slower the sedimentation rate (DALTIN, 2011). Therefore, considering that the emulsions obtained present small droplets with a spherical and regular shape, it is seen that the emulsions obtained present high stability.

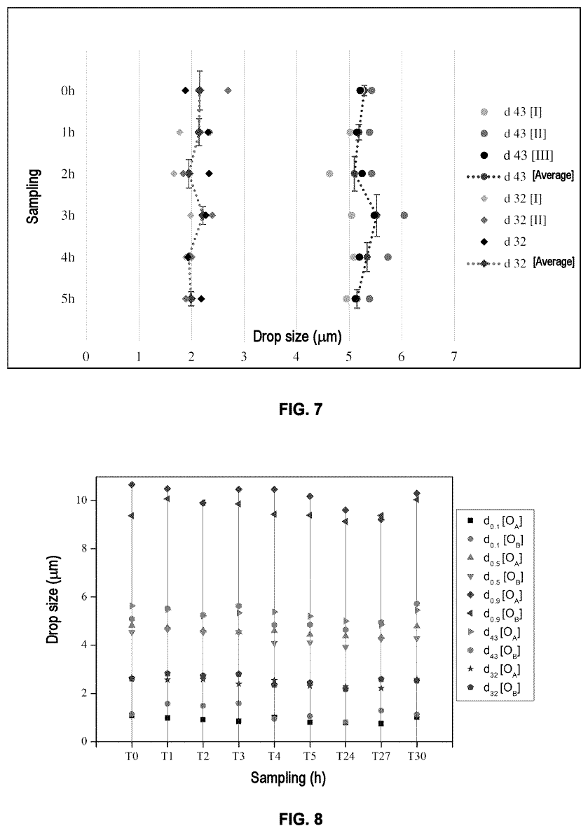

Reproducibility of the preparation process: The reproducibility of the preparation of a water-in-oil emulsion (30:70) (W_{A}:O_{A}) with 5% w/v (Tw80Sp80) was evaluated. Three different batches (marked as I, II and III) were prepared, and over 5 hours the drop size of the sample was measured, with the aim of observing whether different batches of the same emulsion formulation would generate any change in the kinetic stability or in the size of the droplets formed. The droplet size measurements (d_{0.1}, d_{0.5}, d_{0.9}, d₄₃, d₃₂, and α) for emulsion samples, as well as their average, are presented in FIG. 7 and Table 3. The visual stability of the samples was also carefully monitored during this period, and the confidence interval was calculated for the average of the readings.

All the tested samples were stable and did not show great variation in the droplet size between the batches. The droplet diameters for the parameters d_{0.1}, d_{0.5}, and d_{0.9} (Table 3) remained in the range of 0.6-11.6 μm. As previously demonstrated, the parameters d₃₂ and d₄₃ replicated values around 2 and 5 μm, respectively (FIG. 7). In addition, the emulsions presented a relatively uniform distribution, and the dispersion values (a) were approximately constant, ranging from 2.0 to 2.3.

TABLE 3
Droplet size parameters (d_{0.1}, d_{0.5}, d_{0.9}) and dispersion values
(α) as a function of the water-in-oil emulsion sampling time

| | Drop Size (μm) | | | | | | | | | | | | |
|---|---|---|---|---|---|---|---|---|---|---|---|---|---|
| | d_{0.1} | | | | d_{0.5} | | | | d_{0.9} | | | | |
| Sample | | | | Average ± | | | | Average ± | | | | Average ± | |
| (h) | I | II | III | S.D. | I | II | III | S.D. | I | II | III | S.D. | α |
| T0 | 0.5 | 0.6 | 0.7 | 0.7 ± 0.1 | 4.3 | 4.9 | 4.2 | 4.4 ± 0.4 | 10.7 | 11.0 | 10.8 | 10.8 ± 0.2 | 2.3 |
| T1 | 0.7 | 0.7 | 0.7 | 0.7 ± 0.0 | 4.1 | 4.7 | 4.3 | 4.4 ± 0.3 | 9.8 | 10.8 | 10.8 | 10.5 ± 0.6 | 2.2 |
| T2 | 0.7 | 0.7 | 0.8 | 0.8 ± 0.0 | 3.8 | 4.3 | 4.4 | 4.2 ± 0.3 | 9.6 | 10.8 | 10.5 | 10.3 ± 0.6 | 2.3 |
| T3 | 0.7 | 0.8 | 0.9 | 0.8 ± 0.1 | 4.4 | 4.9 | 4.7 | 4.6 ± 0.2 | 9.6 | 10.1 | 11.2 | 10.3 ± 0.8 | 2.0 |
| T4 | 0.7 | 1.0 | 0.7 | 0.8 ± 0.2 | 4.3 | 4.6 | 4.3 | 4.4 ± 0.2 | 10.3 | 11.6 | 11.2 | 11.0 ± 0.6 | 2.3 |
| T5 | 0.7 | 0.8 | 0.8 | 0.8 ± 0.1 | 4.3 | 4.4 | 4.2 | 4.3 ± 0.1 | 10.0 | 10.8 | 11.5 | 10.8 ± 0.8 | 2.3 |

| | | | |
|---|---|---|---|
| C.I. | 0.7-0.8 | 4.3-4.5 | 10.4-10.8 |

where: C.I. refers to the confidence interval. S.D. refers to the standard deviation.

These results demonstrate that the proposed system is reproducible in terms of droplet size and, therefore, long-term stability. It is important to mention that the emulsions I, II and III were visually monitored for a period of 30 hours after their preparation and, during this period, the samples remained stable, without any phase separation.

Different types of mineral oil: The influence of the viscosity of the oil phase on the drop size and emulsion stability was also investigated. Three types of mineral oil with different viscosities ranging from approximately 17 cP to approximately 24 cP (approximately 17 mPa·s to 24 mPa·s) were used in the emulsification process. The emulsion samples were prepared by mixing 30% W_{A}, 5% (w/v) Tw80Sp80 mixture, and 70% O_{A} (approximately 18 cP), O_{B}(approximately 17 cP), or Od (approximately 24 cP).

Solubility tests in mineral oil and distilled water were performed for all systems obtained for the purpose of characterizing the emulsion type. As stated by Becher (1977), the continuous phase (external phase) of the emulsion and the emulsion exhibit similar wettability and dispersion properties. That is, if a small amount of an oil-in-water (O/W) emulsion was poured into an aqueous medium, its continuous phase would dissolve in the aqueous solvent and its oil droplets would be dispersed. On the other hand, in a water-in-oil (W/O) emulsion, the solubilization would occur in the presence of an organic and/or oily medium. In theory, the continuous phase of the emulsion governs its affinity with the environment to which it is added (BECHER, 1977).

In a beaker with a capacity of 50 mL, 1 mL of emulsion was transferred to the bottom corner of the beaker and then 20 mL of solvent were added. After the transfer of the solvent, the beaker was manually and gently stirred for 30 seconds and left to rest for 15 minutes. Another manual stirring of 30 s was performed after the resting time.

Only the emulsion prepared with O_{C} was of the oil-in-water type, since the aliquot of the emulsion was solubilized in distilled water instead of in an oily medium. However, an opposite behavior was observed for the other two emulsion samples, that is, O_{A} and O_{B} were of the water-in-oil type. The inverted trend for the oil-in-water emulsion with O_{C} may be associated with some factors: the higher viscosity of the oil, the HLB value of the surfactant and the viscosity of the surfactant.

According to MCCLEMENTS (2015), surfactants with intermediate values between 7 and 10 have no preference for water or oil and are good wetting agents; for this reason, the surfactants are generally mixed in order to provide oil-water stabilization of the interfacial film together (MCCLEMENTS, 2015, SJOBLOM, 2001). However, the viscosity of the continuous phase can play an important role in the diffusion of the surfactant through the medium, that is, the more viscous the surfactant, the more difficult it will be in the competition for the droplet stabilization with another surfactant in the medium. This theory can justify the inversion phase of the emulsion, since Lindner et al. stated that Sp80 is more viscous than Tw80; therefore, Tw80 is able to easily permeate into its affinity phase and stabilize oil droplets instead of water droplets (LINDNER, BAUMLER, et al., 2018).

FIG. 8 showed the results of the drop size parameters as a function of time for the emulsion sample prepared with O_{A} and O_{B}. In this graph, it is possible to observe that the drop diameters converge to practically the same values for both mineral oils. The similar drop size distribution behavior obtained for Isofar and EMCA oils should be associated with the proximity between their viscosities, namely: approximately 17 cP and approximately 18 cP (approximately 17 mPa·s and 18 mPa·s), respectively. Both samples remained stable over the 30 h period, without phase separation.

It is worth emphasizing that both samples remained stable over the 30 h period, without a phase separation. Therefore, it is seen that the viscosity of the oily range in a range from about 15 cP (mPa·s) to about 23 cP (23 mPa·s) promotes the drop size distribution, consequently the high stability.

Aqueous phase salinity: The effect of the brine (aqueous phase) salinity on the emulsion stability was also investigated. Different emulsion samples were prepared by mixing mineral oil (70% O_{A}), surfactant mixture (Tw80Sp80) and brines (30% W_{B}) with different NaCl concentrations (35,000, 55,000, 140,000 or 220,000 mg/L). NaCl was used in the brine preparation only as an example, but other salts could also be applied in the formulation of the water-in-oil emulsion.

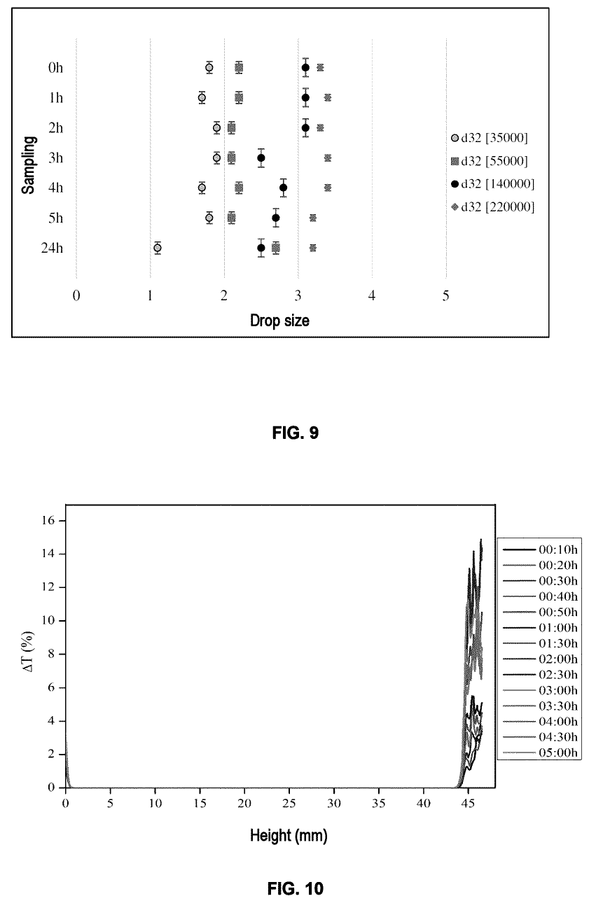

The drop size parameters such as d₄₃ (weight-volume average diameter), d₃₂ (volume-surface average diameter) and the dispersion value (av) were determined over the 24 h period and presented in FIG. 9 and Table 4. The graph in FIG. 9 showed that for each emulsion sample, the droplet sizes did not change significantly over time. However, as the salinity of the brine was increased, the drop diameters obtained were slightly larger, that is, from ˜1.5 to 3.5 μm.

Maaref et al. in their study (2017) also observed the same behavior, where the drop size distribution curves of the emulsions changed to larger sizes as the salinity of the brine increased. The researchers associated the destabilization with the high ionic strength of the brine, in which dispersed phase droplets become larger due to the faster aggregation and coalescence; therefore, the emulsions tend to become unstable over time (MAAREF, AYATOLLAHI, 2017).

In terms of visual stability, all the samples were stable over 5 h, although after a full day (24 h) only the emulsion with 35,000 mg/L of NaCl remained without phase separation. As seen in Table 4, although the droplet diameters were similar, the emulsions of 55,000 to 220,000 mg/L of NaCl after the 24 h period became destabilized, and presented an oil ring on top of the samples.

TABLE 4
Drop size parameters, d₄₃ (weight-volume average diameter) and dispersion values
(α) for an emulsion prepared with different concentrations of NaCl (35,000,
55,000, 140,000 or 220,000 mg/L) as a function of the sampling time.

| | Drop Size (μm) | | | | | | | |
|---|---|---|---|---|---|---|---|---|
| | d₄₃ | | | | α | | | |
| Sample | NaCl (mg · L⁻¹) | | | | | | | |
| (h) | 35,000 | 55,000 | 140,000 | 220,000 | 35,000 | 55,000 | 140,000 | 220,000 |
| T0 | 3.1 | 4.1 | 3.7 | 3.6 | 1.8 | 1.8 | 1.1 | 0.9 |
| T1 | 2.9 | 4.4 | 3.7 | 3.8 | 1.8 | 1.7 | 1.1 | 0.9 |
| T2 | 3.1 | 3.8 | 3.7 | 3.7 | 1.8 | 1.7 | 1.2 | 1.0 |
| T3 | 3.4 | 3.6 | 3.4 | 3.8 | 1.7 | 1.7 | 1.3 | 0.9 |
| T4 | 2.9 | 3.3 | 3.5 | 3.8 | 1.8 | 1.6 | 1.2 | 1.0 |
| T5 | 2.8 | 3.2 | 3.6 | 3.5 | 1.7 | 1.6 | 1.4 | 0.9 |
| T24 | 2.2 | 4.5 | 3.4 | 3.5 | 1.8 | 1.8 | 1.8 | 0.9 |
| C.I. | 2.7-3.2 | 3.5-4.2 | 3.5-3.7 | 3.6-3.7 | — | | | |
| S.D. | ±0.4 | ±0.5 | ±0.1 | ±0.01 | | | | |

where: C.I. refers to the confidence interval and S.D. refers to the standard deviation.

According to Belhaj et al. (2019), this behavior can be explained by the fact that the salinity also has an impact on the non-ionic surfactants, which can alter their solubility, surface activity and adsorption at the solid-liquid interface, thus leading to the interfacial rupture of the droplet and, therefore, to the separation of the aqueous-oily phase (BELHAJ, et al., 2020, PARIA, KHILAR, 2004).

Stability measured by Turbiscan: The Turbiscan Lab (Formulation) is an equipment used to analyze various types of dispersions such as emulsions, suspensions and foams. It is used to provide information on destabilization mechanisms, e.g. sedimentation, coalescence, flocculation and creaming, which are not detectable with the naked eye. The analyzer is equipped with a pulsed near-infrared light source (λ=880 nm) and two optical detectors: transmission (T) and backscatter (BS). The transmittance detector receives the light that has passed through the scattering at an angle of 180° to the source, if measured from the axis of the cylindrical emulsion cuvette, while the backscatter detector receives the light scattered back by the scattering at an angle of 45°. The two sensors scanned the entire height (approximately 50 mm) of the cylindrical glass tube where the sample is placed, acquiring T and BS data every 40 μm. The stability analysis was performed by interpreting the variation of the backscattering (ΔBS) and transmittance (ΔT) profiles of the light as a function of the height of the glass tube, according to the following formula (KANG, GUO, et al., 2012):

$$B S \approx \frac{1}{\sqrt{{l}^{*}}} \qquad [ Equation 6 ]$$

$${l}^{*} ( d , φ ) = \frac{2 d}{3 φ ( 1 - g ) Q s} \qquad [ Equation 7 ]$$

$$T \approx {T}_{0} \cdot {e}^{- \frac{2 r i}{l}} \qquad [ Equation 8 ]$$

wherein l* represents the average free path of photon transport, φ represents the particle volume fraction, d refers to the average diameter of the drop, g and Qs are the optical parameters given by Mie theory, ri represents the inner radius of the measurement cell, T₀ is the transmittance of the continuous phase (MENGUAL et al., 1999).

The backscattering and transmittance data were used to generate ΔBS and ΔT profiles, respectively, by using Turbiscan EasySoft Converter. The Turbiscan Stability Index (TSI) is also a parameter used to assess the stability of the dispersed system. The TSI value directly determines the stability of the samples, that is, large TSI values correspond to unstable emulsions (L U et al., 2017). Equation 9 is the determination for the TSI:

$$TSI = \sqrt{\frac{{\sum }_{i = 1}^{n} {( {x}_{i} - {x}_{BS} )}^{2}}{n - 1}} \qquad [ Equation 9 ]$$

where xᵢ denotes the BS average, x_{BS} represents the xi average, and n indicates the number of scans.

Immediately after preparing the emulsion, the measuring cell was filled with 20 mL of the sample to be analyzed at a temperature of 30° C. The entire height of the emulsion sample was scanned for 5 hours. In addition, the macroscopic stability of the sample was also carefully visually monitored. The stability analysis was performed by interpreting the variation of the backscattering (ΔBS) and transmittance (ΔT) profiles of the light as a function of the height of the glass tube, and the scanning process was divided into two steps: firstly, scanned for 1 hour every 10 min; then, scanned for another 4 hours every 30 minutes.

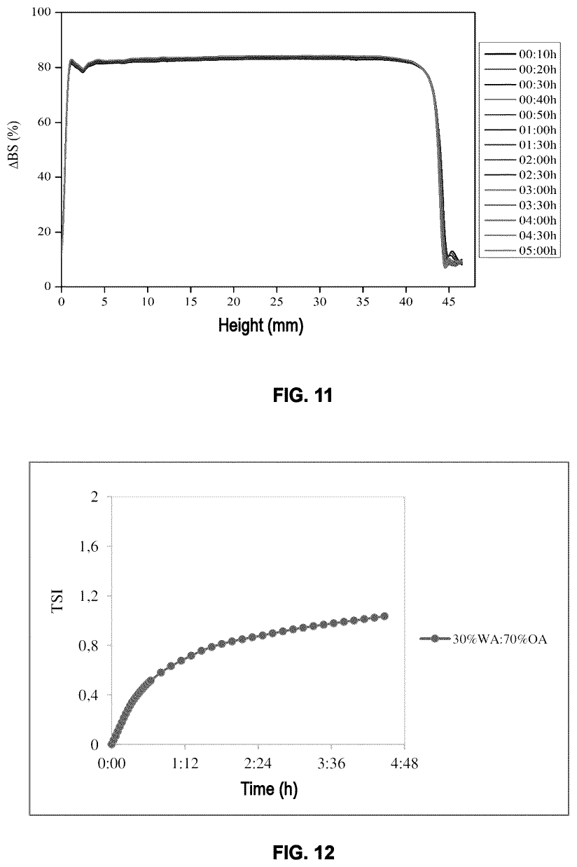

FIGS. 10 and 11 show an example of the typical transmission and backscattering profiles, respectively, obtained from a water-in-oil emulsion sample. The horizontal axis corresponds to the height of the sample from bottom to top. However, only the backscattered light profile was evaluated, since the emulsion was opaque and presented zero light transmission throughout the height of the vial, as demonstrated in FIG. 10. The increase in the signal at the top of the vial, around ˜45 mm, is related to the sample-air interface, and not to any process of destabilization.

FIG. 11 shows the profile of the backscatter signal as a function of the height of a vial. In this graph, it is possible to observe an increase in the backscatter signal at the bottom of the vial (on the left side of the profiles) and a decrease at the top of the vial. However, no changes in the BS signal in the medium are observed over time (5 h). All signals appear to be uniform throughout the height of the vial, which are characteristics of a stable emulsion, according to Lindner et al. (2018). Changes in the particle size, due to the agglomeration or coalescence, provide a decrease in the intensity of the delta BS light and variations in the position of the curve in the middle zone of the vial (LINDNER et al., 2018, SUN et al., 2019).

The TSI value of the water-in-oil emulsion was calculated and plotted as a function of time and presented in FIG. 12. As stated by Lu et al. (2017), the lower the TSI value, the more stable the emulsion. Therefore, the low TSI result obtained indicates that the 30:70 (W_{A}:O_{A}) emulsion presents high stability over the analyzed time, and this result is also consistent with the other obtained results.

Thus, from the analyses carried out regarding the stability and reproducibility of the prepared water-in-oil emulsion, it is seen that the emulsions prepared by the method of the present invention present high stability, since no changes were observed in the droplet sizes for the measured emulsion.

In this way, it is seen that the choice of the surfactants, the volumetric fraction of water and oil and the concentration used for the production of water-in-oil emulsion are fundamental to provide a high emulsion stability, for at least 30 hours, without increase or decrease in the droplet size. The system (30W_{A}:70O_{A} with 5% w/v Tw80Sp80) was reproducible in terms of stability and drop size distribution.

### BIBLIOGRAPHIC REFERENCES

ALMEIDA, M. L., CHARIN, R. M., NELE, M., et al. “Stability studies of high-stable water-in-oil model emulsions”, Journal of Dispersion Science and Technology, v. 38, n. 1, p. 82-88, 2017. DOI: 10.1080/01932691.2016.1144195.
ALVARADO, V., WANG, X., MORADI, M. “Role of acid components and asphaltenes in Wyoming water-in-crude oil emulsions”, Energy and Fuels, v. 25, n. 10, p. 4606-4613, 2011. DOI: 10.1021/ef2010805.
BECHER, P. Emulsions: Theory and practice. Reprint ed. New York, Krieger Pub Co, 1977.
BELHAJ, A. F., ELRAIES, K. A., MAHMOOD, S. M., et al. “The effect of surfactant concentration, salinity, temperature, and pH on surfactant adsorption for chemical enhanced oil recovery: a review”, Journal of Petroleum Exploration and Production Technology, v. 10, n. 1, p. 125-137, 2020. DOI: 10.1007/s13202-019-0685-y. Available at: https://doi.org/10.1007/s13202-019-0685-y.
BRADLEY, H. B., GIPSON, F. W. Petroleum engineering handbook. [S.1.], Society of Petroleum Engineers, 1987. Available at: https://books.google.com.br/books?id=EvZPAQAAIAAJ.
BRYANT, S. J., DA SILVA, M. A., HOSSAIN, K. M. Z., et al. “Deep eutectic solvent in water pickering emulsions stabilized by cellulose nanofibrils”, RSC Advances, v. 10, n. 61, p. 37023-37027, 2020. DOI: 10.1039/d0ra07575b.
BURON, H., MENGUAL, O., MEUNIER, G., et al. “Optical characterization of concentrated dispersions: Applications to laboratory analyses and on-line process monitoring and control”, Polymer International, v. 53, n. 9, p. 1205-1209, 2004. DOI: 10.1002/pi.1231.
CHEN, G., TAO, D. “An experimental study of stability of oil-water emulsion”, Fuel Processing Technology, v. 86, n. 5, p. 499-508, 2005. DOI: 10.1016/j.fuproc.2004.03.010.
DALTIN, D. Tensoativos: quimica, propriedades e aplicaQoes. [S.l.], Editora Blucher, 2011. Available at: https://books.google.com.br/books?id=HIy0DwAAQBAJ.
DAVIES, R., GRAHAM, D. E., VINCENT, B. “Watercyclohexane—“Span 80”—“Tween 80” systems: Solution properties and water/oil emulsion formation”, Journal of Colloid And Interface Science, v. 116, n. 1, p. 88-99, 1987. DOI: 10.1016/0021-9797(87)90101-9.
DELGADO-LINARES, J. G., MAJID, A. A. A., SLOAN, E. D., et al. “Model water-in-oil emulsions for gas hydrate studies in oil continuous systems”, Energy and Fuels, v. 27, n. 8, p. 4564-4573, 2013. DOI: 10.1021/ef4004768.
EL-DIN, M. R. N. “Study on the stability of water-in-kerosene nano-emulsions and their dynamic surface properties”, Colloids and Surfaces A: Physicochemical and Engineering Aspects, v. 390, n. 1-3, p. 189-198, 2011. DOI: 10.1016/j.colsurfa.2011.09.027.
EOW, J. S., GHADIRI, M., SHARIF, A. O., et al. “Electrostatic enhancement of coalescence of water droplets in oil: A review of the current understanding”, Chemical Engineering Journal, v. 84, n. 3, p. 173-192, 2001. DOI: 10.1016/S1385-8947(00)00386-7.
ESTABILIDADE DE EMULSOES DE ÁGUA-EM-ÓLEO NA PRESENQA DE CAMPO ELETRICO EXTERNO, Monique Lombardo de Almeida. 2014. 103 f. Universidade Federal do Rio de Janeiro, 2014.
FERNANDEZ, P., ANDRÉ, V., RIEGER, J., et al. “Nano-emulsion formation by emulsion phase inversion”, Colloids and Surfaces A: Physicochemical and Engineering Aspects, v. 251, n. 1-3, p. 53-58, 2004. DOI: 10.1016/j.colsurfa.2004.09.029.
FU, Z., LIU, M., XU, J., et al. “Stabilization of water-in-octane nano-emulsion. Part I: Stabilized by mixed surfactant systems”, Fuel, v. 89, n. 10, p. 2838-2843, 2010. DOI: 10.1016/j.fuel.2010.05.031. Available at: http://dx.doi.org/10.1016/j.fuel.2010.05.031.
GOUAOU, I., SHAMAEI, S., KOUTCHOUKALI, M. S., et al. “Impact of operating conditions on a single droplet and spray drying of hydroxypropylated pea starch: Process performance and final powder properties”, Asia-Pacific Journal of Chemical Engineering, v. 14, n. 1, p. 1-18, 2019. DOI: 10.1002/apj.2268.
GRIFFIN, W. C. Classification of Surface-Active Agents by “HLB”. Journal of Cosmetic Science, v. 1, p. 311-326, 1949. Available at: journal.scconline.org/contents/cc1949/cc001n05.html
INTERNATIONAL ORGANIZATION FOR STANDARDIZATION. Particle size analysis—Laser diffraction methods. ISO 13320:2009. Geneva: ISO, 2009.
KANG, W., GUO, L., FAN, H., et al. “Flocculation, coalescence and migration of dispersed phase droplets and oil-water separation in heavy oil emulsion”, Journal of Petroleum Science and Engineering, v. 81, p. 177-181, 2012. DOI: 10.1016/j.petrol.2011.12.011. Available at: http://dx.doi.org/10.1016/j.petrol.2011.12.011.
KLOET, J. V., SCHRAMM, L. L. “The effect of shear and oil/water ratio on the required hydrophile-lipophile balance for emulsification”, Journal of Surfactants and Detergents, v. 5, n. 1, p. 19-24, 2002. DOI: 10.1007/s11743-002-0200-6.
KOWALSKA, M., ZBIKOWSKA, A., WOZNIAK, M., et al. “Long-term stability of emulsion based on rose oil”, p. 36-41, 2016.
LINDNER, M., BAUMLER, M., STABLER, A. “Intercorrelation among the hydrophilic-lipophilic balance, surfactant system, viscosity, particle size, and stability of candelilla wax-based dispersions”, Coatings, v. 8, n. 12, 2018. DOI: 10.3390/COATINGS8120469.
LING, N. N. A., HABER, A., GRAHAM, B. F., et al. “Quantifying the Effect of Salinity on Oilfield Water-in-Oil Emulsion Stability”, Energy and Fuels, v. 32, n. 9, p. 10042-10049, 2018. DOI: 10.1021/acs.energyfuels.8b02143.
LU, Y., KANG, W., JIANG, J., et al. “Study on the stabilization mechanism of crude oil emulsion with an amphiphilic polymer using the β-cyclodextrin inclusion method”, RSC Advances, v. 7, n. 14, p. 8156-8166, 2017. DOI: 10.1039/c6ra28528g.
MAAREF, S., AYATOLLAHI, S. “The effect of brine salinity on water-in-oil emulsion stability through droplet size distribution analysis: A case study”, Journal of Dispersion Science and Technology, v. 39, n. 5, p. 721-733, 2017. DOI: 10.1080/01932691.2017.1386569.
MCCLEMENTS, D. J. “Edible nanoemulsions: Fabrication, properties, and functional performance”, Soft Matter, v. 7, n. 6, p. 2297-2316, 2011. DOI: 10.1039/cOsm00549e.
MCCLEMENTS, D. J. Food Emulsions Principles, Practices, and Techniques. [S.l.: s.n.], 2015.
MENGUAL, O., MEUNIER, G., CAYRE, I., et al. “TURBISCAN MA 2000: multiple light scattering measurement for concentrated emulsion and suspension instability analysis”, Talanta, v. 50, n. 2, p. 445-456, 1999.
MIRHOSSEINI, H., TAN, C. P., HAMID, N. S. A., et al. “Effect of Arabic gum, xanthan gum and orange oil contents on ζ-potential, conductivity, stability, size index and pH of orange beverage emulsion”, Colloids and Surfaces A: Physicochemical and Engineering Aspects, v. 315, n. 1-3, p. 47-56, 2008. DOI: 10.1016/j.colsurfa.2007.07.007.
MIRHOSSEINI, H., TAN, C. P., HAMID, N. S. A., et al. “Modeling the relationship between the main emulsion components and stability, viscosity, fluid behavior, ζ-potential, and electrophoretic”, Journal of agricultural and food chemistry, v. 55, n. 19, p. 7659-7666, 2007.
MOBIUS, D., MILLER, R., FAINERMAN, V. B. Surfactants: Chemistry, Interfacial Properties, Applications. [S.l.], Elsevier Science, 2001. Available at: https://books.google.com.br/books?id=delDjh2AlTUC. (ISSN).
MORADI, M., ALVARADO, V., HUZURBAZAR, S. “Effect of salinity on water-in-crude oil emulsion: Evaluation through drop-size distribution proxy”, Energy and Fuels, v. 25, n. 1, p. 260-268, 2011. DOI: 10.1021/ef101236h.
MOSCA, M., CEGLIE, A., AMBROSONE, L. “Biocompatible water-in-oil emulsion as a model to study ascorbic acid effect on lipid oxidation”, Journal of Physical Chemistry B, v. 112, n. 15, p. 4635-4641, 2008. DOI: 10.1021/jp710120z.
PARIA, S., KHILAR, K. C. “A review on experimental studies of surfactant adsorption at the hydrophilic solid water interface”, Advances in Colloid and Interface Science, v. 110, n. 3, p. 75-95, 2004. DOI: 10.1016/j.cis.2004.03.001.
PASQUALI, R. C., TAUROZZI, M. P., BREGNI, C. “Some considerations about the hydrophilic-lipophilic balance system”, International Journal of Pharmaceutics, v. 356, n. 1-2, p. 44-51, 2008. DOI: 10.1016/j.ijpharm.2007.12.034.
REN, Y., ZHENG, J., XU, Z., et al. “Application of Turbiscan LAB to study the influence of lignite on the static stability of PCLWS”, Fuel, v. 214, n. July 2017, p. 446-456, 2018. DOI: 10.1016/j.fuel.2017.08.026.
ROSEN, M. J. Surfactants and Interfacial Phenomena. [S.l.], Wiley, 2004. Available at: https://books.google.com.br/books?id=fn_NcYDOfdQC. (A Wiley-Interscience publication).
SAMAVATI, V., EMAM-DJOMEH, Z., MOHAMMADIFAR, M. A. “Physical and Rheological Characteristics of Emulsion Model Structures Containing Iranian Tragacanth Gum and Oleic Acid”, Journal of Dispersion Science and Technology, v. 34, n. 12, p. 1635-1645, 2013. DOI: 10.1080/01932691.2012.731645.
SCHRAMM, L. L. Emulsions, Foams, and Suspensions: Fundamentals and Applications. [S.l.: s.n.], 2006.
SJOBLOM, J. Encyclopedic Handbook of Emulsion Technology. [S.l.], CRC Press, 2001. Available at: https://books.google.com.br/books?id=Q4wwWbQTivUC.
SJOBLOM, J., STENIUS, P., SIMON, S., et al., “Emulsion Stabilization BT—Encyclopedia of Colloid and Interface Science”. In: TADROS, THARWAT (Org.), Berlin, Heidelberg, Springer Berlin Heidelberg, 2013. p. 415-454. DOI: 10.1007/978-3-642-20665-8_83. Available at: https://doi.org/10.1007/978-3-642-20665-8_83.
STAUFFER, Clyde E. Emulsifiers Handbook. 1. ed. New York: Eagan Press, 1997. 102 p. ISBN 1891127020.
SULLIVAN, A. P., ZAKI, N. N., SJOBLOM, J., et al. “The stability of Water-in-crude and model oil emulsions”, Canadian Journal of Chemical Engineering, v. 85, n. 6, p. 793-807, 2007. DOI: 10.1002/cjce.5450850601.
SUN, Y., DEAC, A., ZHANG, G. G. Z. “Assessing Physical Stability of Colloidal Dispersions Using a Turbiscan Optical Analyzer”, Molecular Pharmaceutics, v. 16, n. 2, p. 877-885, 2019. DOI: 10.1021/acs.molpharmaceut.8b01194.
SZYMANSKA, I., ZBIKOWSKA, A., MARCINIAK-LUKASIAK, K. “Effect of addition of a marine algae (Chlorella protothecoides) protein preparation on stability of model emulsion systems”, Journal of Dispersion Science and Technology, v. 41, n. 5, p. 699-707, 2020. DOI: 10.1080/01932691.2019.1611438. Available at: https://doi.org/10.1080/01932691.2019.1611438.
TADROS, T. F. Emulsion Science and Technology. [S.1.], Wiley, 2009. Available at: https://books.google.com.br/books?id=3TPVwAEACAAJ.
TADROS, T. Applied Surfactants: Principle and Applications. [S.l.], WILEY-VCH Verlag GmbH & Co. Weinheim, 2005.
TAMBE, D., SHARMA, M. “Factors Controlling the Stability of Colloid-Stabilized Emulsions: I. An Experimental Investigation”, Journal of Colloid and Interface Science, v. 157, p. 244-253, 1993. Available at: https://www.sciencedirect.com/science/article/abs/pii/50021 979783711823.
VELAYATI, A., NOURI, A. “Role of Asphaltene in Stability of Water-in-Oil Model Emulsions: The Effects of Oil Composition and Size of the Aggregates and Droplets”, Energy and Fuels, v. 35, n. 7, p. 5941-5954, 2021. DOI: 10.1021/acs.energyfuels.lc00183.
VLADISAVLJEVIC, G. T., SCHUBERT, H. “Preparation of emulsions with a narrow particle size distribution using microporous α-alumina membranes”, Journal of Dispersion Science and Technology, v. 24, n. 6, p. 811-819, 2003. DOI: 10.1081/DIS-120025549.
ZHANG, Y., LIU, Y., JI, R., et al. “Dehydration Efficiency of Water-In-Model Oil Emulsions in High Frequency Pulsed DC Electrical Field: Effect of Physical and Chemical Properties of the Emulsions”, Journal of Dispersion Science and Technology, v. 33, n. 11, p. 1574-1581, 2012. DOI: 10.1080/01932691.2011.625227.

1. A process for preparing water-in-oil emulsions, wherein the process comprises:
(i) defining one or more water:oil proportions in the emulsion, based on the interest of applying the standard emulsion; and
(ii) defining the composition/salinity of the aqueous phase and the type of oil to be used;
based on information (i) and (ii) above:
(iii) choosing the hydrophilic-lipophilic balance (HLB) of interest for the standard emulsion and one or more surfactants to be used;
(iv) dissolving one or more specific surfactants for each phase of interest,
wherein the dissolution occurs according to the affinity between the phases, considering the proportions found from the HLB calculation;
(v) mixing the phases; and
(vi) homogenization.

2. The process according to claim 1, wherein:
the water:oil ratio in the emulsion to be prepared is in the range of 10:90 to 40:60;
the aqueous phase has a salinity in a range of 0 to 400,000 mg of salt/L;
the HLB of interest of the emulsion is in the range of 4.3 to 15; and/or
1% to 5% (w/v) of one or more surfactants are added, based on the total amount of the emulsion.

3. The process according to claim 2, wherein:
the water:oil ratio in the emulsion to be prepared is in the range of 30:70 to 40:60;
the aqueous phase has a salinity in a range of 0 to 220,000 mg of salt/L;
the HLB of interest of the emulsion is in the range of 6 to 10; and/or
5% (w/v) of one or more surfactants are added, based on the total amount of the emulsion.

4. The process according to claim 3, wherein the HLB of interest of the emulsion is equal to 6.

5. The process according to claim 1, wherein:
the oil phase comprises oil selected from the group consisting of crude oil, mineral oil, base oil, lubricating oil, drilling oil, synthetic oils, oily materials based on alpha-olefins or other oligomeric types, petroleum derivatives, fuel oil or diesel, crude oil, and combinations thereof; and/or
one or more surfactants are selected from the group consisting of sorbitan monooleate, ethoxylated/propoxylated sorbitan monooleate, sorbitan trioleate, ethoxylated/propoxylated sorbitan trioleate, sorbitan sesquioleate, ethoxylated/propoxylated sorbitan sesquioleate, sodium oleate, sodium stearate, calcium stearate, ethoxylated lauryl ether, ethoxylated castor oil, ethoxylated/propoxylated isotridecyl alcohol, and combinations thereof.

6. The process according to claim 5, wherein the petroleum derivative is aviation kerosene.

7. The process according to claim 1, wherein one or more hydrophilic surfactants are dissolved in the aqueous phase, and/or one or more hydrophobic surfactants are dissolved in the oil phase.

8. The process of claim 1, wherein:
the mixing of the phases occurs through the pouring of the aqueous phase into the oil phase; and/or
the homogenization occurs through vigorous stirring.

9. The process of claim 8, wherein:
the pouring of the aqueous phase into the oil phase occurs slowly, and/or
the homogenization occurs through vigorous stirring with mechanical stirring systems with a rotation speed of 3000 to 13000 rpm.

10. The process of claim 1, wherein the process additionally comprises a step of characterizing the emulsion, in which the drop size is analyzed, and solubility test in aqueous medium and in oily medium, wettability tests, membrane filtration, interface tests, spectrophotometry are performed.

11. A water-in-oil emulsion, comprising from 10% to 40% of an aqueous phase, based on the total weight of the emulsion, dispersed in 60% to 90% of an oil phase, based on the total weight of the emulsion; and from 1% (w/v) to 5% (w/v) of one or more surfactants;
wherein the water-in-oil emulsion presents high stability.

12. The water-in-oil emulsion according to claim 11, wherein:
the emulsion comprises 5% (w/v) of surfactants, based on the emulsion;
the aqueous phase has a salinity in a range of 0 to 400,000 mg of salt/L; and/or
the emulsion has an HLB value between 4.3 and 15.

13. The water-in-oil emulsion according to claim 12, wherein:
the aqueous phase has a salinity in a range of 0 to 220,000 mg of salt/L,
the emulsion has an HLB value between 4.3 and 15;
the oil phase comprises oil selected from the group consisting of crude oil, mineral oil, base oil, lubricating oil, drilling oil, synthetic oils, oily materials based on alpha-olefins or other oligomeric types, petroleum derivatives, fuel oil or diesel, crude oil, and combinations thereof, and/or
the emulsion comprises a surfactant selected from the group consisting of sorbitan monooleate, ethoxylated/propoxylated sorbitan monooleate, sorbitan trioleate, ethoxylated/propoxylated sorbitan trioleate, sorbitan sesquioleate, ethoxylated/propoxylated sorbitan sesquioleate, sodium oleate, sodium stearate, calcium stearate, ethoxylated lauryl ether, ethoxylated castor oil, ethoxylated/propoxylated isotridecyl alcohol, and combinations thereof.

14. The water-in-oil emulsion according to claim 13, wherein the emulsion has an HLB equal to 6.

15. The water-in-oil emulsion according to claim 13, wherein the petroleum derivative is aviation kerosene.

16. The water-in-oil emulsion according to claim 11, where the emulsion comprises one or more hydrophilic surfactants and/or one or more hydrophobic surfactants.

17. The water-in-oil emulsion according to claim 11, wherein the emulsion is stable for at least 5 h.

18. The water-in-oil emulsion according to claim 17, wherein the emulsion is stable for at least 30 h.

19. The water-in-oil emulsion according to claim 11, wherein:
the emulsion has a dispersion of drops with drop sizes in the range of 1 to 10 μm;
the emulsion is white or off-white in appearance, opaque and free of characteristic odor; and/or
the emulsion is a standard synthetic water-in-oil emulsion.

20. A method of applying standard synthetic water-in-oil emulsions for physical-chemical analyses in a petroleum field, wherein the method comprises applying the water-in-oil emulsion as defined in claim 11.
